(19) United States
(12) Patent Application Publication
(10) Pub. No.: US 2005/0235013 A1
(43) Pub. Date: Oct. 20, 2005

(54) Flow control method of data service transmission in sdh network

(76) Inventors: Kun Li, Shenzhen (CN); Fenglin Li, Shenzhen (CN); Ke Huang, Shenzhen (CN); Yongjun Deng, Shenzhen (CN)

Correspondence Address: VENABLE LLP, P.O. BOX 34385, WASHINGTON, DC, 20045-9998, US

(21) Appl. No.: 10/523,796

(22) PCT Filed: Aug. 8, 2003
(86) PCT No.: PCT/CN03/00643

§ 371 Date: Feb. 8, 2005

(30) Foreign Application Priority Data
Aug. 10, 2002 (CN) 02130031.3

(51) Int. Cl. G06F 12/00

(52) U.S. Cl. 707/204

(57) ABSTRACT

A flow-control method for data traffic transmitted through SDH network, wherein: during data transmission through the SDH network, the EoS device generates and encapsulates LFP frames, maps the LFP frames into SDH payload, and transmits the SDH payload to the opposite device, which demaps the LFP frames from the SDH payload and executes the flow control information carried in the LFP frames; the carrier of the LFP frames may be standard PAUSE frame structure defined by 802.3x; LFP frame transparent or LFP frame regeneration may be used when the EoS device identifies LFP frames; the present invention is a high-performance method for flow control of data transmission, with high applicability and reliability.

### CROSS-REFERENCE TO RELATED APPLICATIONS

This application derives priority from PCT International Application No. PCT/CN2003/000643, filed on Aug. 8, 2003, which designates the United States, and which derives priority from Chinese Application No. 02130031.3, filed on Aug. 10, 2002, both of which are incorporated by reference herein.

### FIELD OF THE INVENTION

The present invention relates to data transmission, particularly to a flow-control method for data traffic transmitted through Synchronous Digital Hierarchy (SDH) network.

### BACKGROUND OF THE INVENTION

As SDH network evolves rapidly, EoS (Ethernet over SDH/SONET) technology is used more and more widely; therefore, how to implement data applications through SDH network efficiently becomes a crucial issue. In Ethernet transmission applications through Metropolitan Area Network (MAN), the distance between two sites can reach 1˜2 hundred km, and virtual cascaded mapping pattern for EoS, so the time delay of data transmission between two sites may be as high as several milliseconds or even tens of milliseconds. In addition, Ethernet traffic has outburst feature, i.e., instantaneous flow rate maybe very large, therefore the instantaneous flow rate may even exceed the pre-assigned bandwidth.

Presently, a common flow-control mechanism is CAR (Committed Access Rate), i.e., in case of network congestion, the data beyond the CAR will be discarded by using priority or others like. A disadvantage of the control mechanism is that it often results in severe packet loss, which will severely degrade network performance in common TCP/IP applications; especially for the TCP/IP protocol that is extensively used, packet loss will result in severely degraded application performance. For example, suppose 10M/b Ethernet devices are used in a TCP application and the AckTime is set as 5s, Frame Loss Ratio (FLR) 1% will result in serviceability degraded by 98% for 1,500-Byte Ethernet frames.

In some EoS devices, the PAUSE frames generated at a user data device may be transferred to the opposite user data device; however, such data transmission devices directly transfer PAUSE frames generated by user data devices, and said method is only suitable for short distance instead of long distance because said PAUSE frames will be delayed during transmission; in addition, if the user device at either end doesn't support PAUSE frames, said method can't be used.

As shown in FIG. 1, the EoS device comprises 3 parts: Ethernet access parts, which comprise Physical Layer (PHY) and Media Access Control (MAC); encapsulating and decapsulating parts, the encapsulation may be LAPS (Link Access Protocol-SDH), HDLC (High Level Data Link Control), or GFP (General Framing Procedure), and mapping and demapping parts, the mapping method may be virtual cascading or cascading.

Suppose the bandwidth of SDH network is 1 VC3 (i.e., 45M at maximum), if the data transmitting rate of user data device A exceeds 1 VC3, the residue Ethernet frames are stacked at the encapsulating part A because the flow at Mapping part A is constant (1 VC3) according to the prior art; when the cache of encapsulating part A is used up, the data in MAC A can't be sent to encapsulating part A any more; therefore, if Ethernet flow control is enabled, PHY+MAC A will send PAUSE frames (full duplex) or back pressure (half duplex) to user device, shown as the dotted line 1 in FIG. 1 (if Ethernet flow control is disabled, MAC A will discard the residue Ethernet frames, referring to IEEE802.3x document for Ethernet flow control), as a result, the transmitting speed of device A will be decreased to below 1 VC3 to prevent packet loss and severely degraded network performance.

If the transmitting speed of device A is lower than 1 VC3 but the receiving speed of device B is less than the transmitting speed of device A due to certain reasons (for example, device B is attached with a plurality of 10M devices but only one of them is working), the traffic from device A to the transmitting end of EoS device B will not be blocked, instead, device B will be blocked; thus, according to the specification in 802.3x, device B will send 802.3x flow-control information (may be PAUSE frames or back pressure signals) to ports of the EoS device, which is directly connected to it (i.e., the dotted line 2 in FIG. 1); according to the specification in 802.3x, the flow-control information will be terminated by MAC B instead of being transferred to device A; at the same time, MAC B will stop sending data to device B, but device A continues sending data at original speed, thus the Ethernet frames from device A stack up at the decapsulating part B or MAC B; when the caches at these positions are used up, packet loss will surely occur at EoS #B; therefore, though both device A and device B are 802.3x Ethernet flow control-supporting devices, packet loss is inevitable after the EoS device. It indicates that traditional 802.3x-based technical solution is unable to ensure Ethernet flow control with EoS devices.

### SUMMARY OF THE INVENTION

The object of the present invention is to provide a high-performance flow-control method for data traffic transmitted through SDH network to realize lossless transparent transmission of Ethernet data through SDH network.

According to the present invention, a flow-control method for data traffic transmitted through SDH network comprises the following steps:
A. During data transmission through SDH network, the EoS processing device creating and encapsulating LFP (Line Flow-Control Protocol) frames according to the utilization condition of the frame cache inside;
B. Said LFP frames being mapped to SDH payload as common data frames and transferred to the opposite device;
C. Said opposite device demapping the SDH payload, and the EoS processing device identifying said LFP frames and phrasing and executing flow control information in the LFP frames.

Said step of creating and encapsulating LFP frames further comprises the following steps:

A1. In the uplink direction of said EoS device, the EoS processing device keeping on monitoring the data volume in the cache inside and creating LFP frames with corresponding control field; if the data volume exceeds the upper threshold, said encapsulating part periodically sending LFP frames, the control field of which controls to stop sending; if the data volume is lower than the lower threshold, said encapsulating part periodically sending LFP frames, the control field of which controls to start sending; if the data volume is between the lower threshold and the upper threshold, said encapsulating part stops sending LFP frames;

A2. Said LFP frames are inserted in the head of the data queue to be encapsulated and is given the priority to encapsulate; if no Ethernet frames are being encapsulated, said LFP frames are encapsulated immediately; otherwise they are encapsulated immediately after the current Ethernet frames are encapsulated.

The carrier of LFP frames can be configured as standard PAUSE frame structure defined by 802.3x .

The advantage of the present invention is: through LFP frames, flow control information is transferred between EoS devices through the SDH network; the EoS devices generate LFP frames and transfer network flow control information between each other so as to achieve lossless transmission of outburst Ethernet data in the SDH network that transmit data periodically, in order to significantly enhance the performance of data applications. The present invention enables transmission of flow control information between EoS devices and also support full duplex or half duplex devices attached to EoS devices, for example, a full duplex device may be attached to one end of the EoS device, and a half duplex device may be attached to the other end of the EoS device, or half duplex devices may be attached to both ends of the EoS device; The EoS processing device keeps on monitoring the data volume in the cache to avoid flow control failure due to some reasons such as LFP frame transmission failures; therefore, the present invention is a high-performance flow-control method for data traffic transmitted through SDH network and has high applicability and reliability.

### BRIEF DESCRIPTION OF THE DRAWINGS

FIG. 1 is a schematic diagram of flow control implemented according to the prior art.

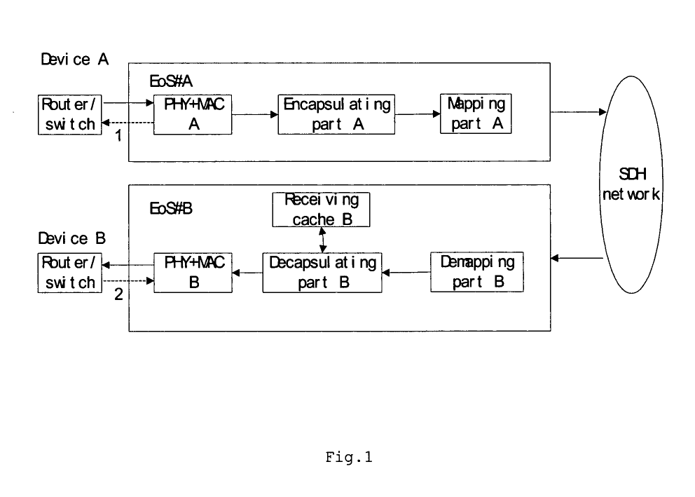

FIG. 2 is a schematic diagram of LFP process according to the present invention.

### DETAILED DESCRIPTION OF THE EMBODIMENTS

The present invention will be described in further detail with reference to the following embodiments and the drawings. The present invention will be described with the example of A-B data transmission; the processing method for B-A data transmission is similar.

In the present invention, during the data transmission through SDH network, the EoS devices transfer flow-control information through LFP frames between them; the carrier of LFP frames can be configured as standard PAUSE frame structure defined by 802.3x.

During SDH mapping, the mapping part of EoS device processes both Ethernet frames and LFP frames as common data frames; the control field of said LFP frames is 0x0FFFFH or 0x0H and is controlled in a Xon/Xoff control way.

In addition, because time delay will be generated during LFP frame transmission, appropriate caches are required to compensate the time delay; the LFP frames are implemented on the basis of in-band management, i.e., LFP frames and common Ethernet data frames are transferred through the same transmission paths.

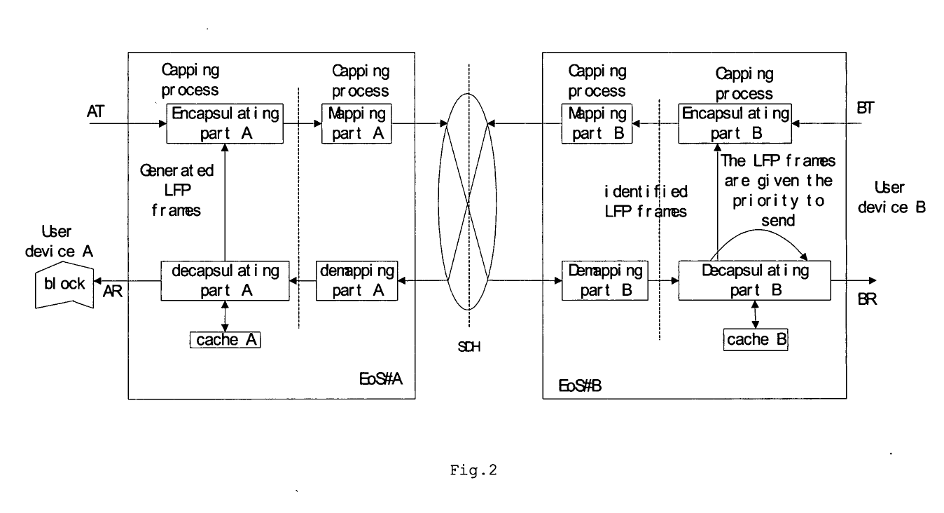

As shown in FIG. 2, in the uplink direction, i.e., the system direction, e.g., the direction of EoS#A-SDH network in FIG. 2, take an example for EoS#A, the EoS processing device, according to the lower/upper threshold of frame cache (reflecting utilization of cache), will generate LFP frames, the control field of which is 0x0FFFFH or 0x0H; said LFP frames are processed as common Ethernet data frames in the mapping part of the EoS processing device; however, to enhance the performance of LFP, the priority is given to the LFP frames to send to the mapping part of the EoS processing device; in the downlink direction i.e., the direction to user device, e.g., the direction of SDH-EoS#B in FIG. 2, the EoS processing device identifies the LFP frames; if the LFP frames are detected, it explains and executes the flow-control information carried in said LFP frames.

If the receiving end (i.e., “AR” shown in FIG. 2) of user device attached to EOS#A is blocked, the data volume in cache A will increase because the demapping part A continues working normally; when the data volume reaches to the preset upper threshold, the EoS device A will generate LFP frames, the control field of which is 0x0FFFFH, and said LFP frames are inserted in the head of data queue at the encapsulating part A and is given the priority to encapsulate. The process is: if there is no Ethernet frames being encapsulated at the encapsulating part A, said LFP frames will be encapsulated immediately; otherwise said LFP frames will be encapsulated immediately after the current Ethernet frame is encapsulated; then the encapsulated LFP frames will be mapped, transferred from the SDH network and the demapping part B to the decapsulating part B, which identifies the LFP frames and processes it in either of the following ways:
1. LFP transparent: This way is suitable for the case in which the network delay is small and the distance between two sites is short. In this way, the EoS device B will phrase and execute the LFP frames according to the characteristic of the data device (full duplex or half duplex) attached to it.

If the user device B attached to the EoS device B works in full duplex mode, the LFP frames will not be phrased, instead, the LFP frames will be directly transferred to the user data device B; the detailed process is: if the decapsulating part B isn't sending data to the Ethernet access part BR, it will send the LFP frames immediately to the Ethernet access part BR; otherwise it will send the LFP frames immediately after the current Ethernet data is sent, in this case, the LFP frames will not pass through cache B in order to enhance its performance.

If the user data device B attached to the EoS device B works in half duplex mode, the control field of the LFP frames should be phrased, i.e., if it is 0x0H, the back pressure control signal will be canceled; otherwise the back pressure control signal will be sent to make the user device B attached to EOS#B detect a conflict and thus stop transmitting Ethernet data to the EoS device B.

2. LFP Regeneration: The EoS device B phrases and executes the LFP frames; if the control field of the LFP frames is not 0x0H, i.e., the EoS device is disabled from sending data, the encapsulating part will stop working, i.e., it stops receiving data from Ethernet access part BT; hower, if the EoS B device itself generates LFP frames at this time, the encapsulating part B still forwards the LFP frames to the mapping part B, i.e., in any cases, the LFP frames shall be forward to the mapping part via the encapsulating part. Thus the data from Ethernet access part BT will stack up at the encapsulating part B and will finally cause the user device B stopping sending Ethernet frames according to 802.3x Ethernet flow control protocol, i.e., no data will be transmitted to BT; if the control field of the LFP frames is 0x0H, i.e., the EoS device is enabled to send data, the encapsulating part B will work normally, and encapsulate and send Ethernet frames from the Ethernet access part BT to the mapping part B.

In this mode, the devices attached to EoS devices at both ends of the SDH network are not required to work in full duplex; instead, they are only required to support standard 802.3x flow control operation. That is to say, the user device at one end may work in full duplex mode while the device at the other end may work in half duplex mode; or the devices at both ends may work in half duplex mode.

After the user device B attached to EOS#B stops sending data to EOS#B, i.e., there is no Ethernet frame input at BT, the data volume in cache A of EOS#A will be reduced gradually; when the data volume reaches to the lower threshold, the decapsulating part A will generate LFP frames, the control field of which is 0x0H; said LFP frames are given the priority to send to the decapsulating part B in EOS#B and is phrased and executed; as a result, the user device B attached to EOS#B will send data again.

In order to avoid LFP control failure due to accidents such as LFP frame transmission failures, the EoS processing device keeps on monitoring the data volume in the cache; when the data volume exceeds the upper threshold or is lower than the lower threshold, the EoS processing device will periodically send LFP frames with corresponding control field; if the data volume is between the upper threshold and the lower threshold, the EoS processing device will stop sending LFP frames; if the data volume exceeds the upper threshold, it will periodically send LFP frames, the control field of which is 0x0FFFFH; if the data volume is lower than the lower threshold, it will periodically send LFP frames, the control field of which is 0x0H.

The lower, upper thresholds and time intervals are configurable, and the time intervals may be different to each other. It is recommended that the time interval for resending LFP frames with the control field 0x0FFFFH should not be too long and the time interval for resending LFP frames with the control field 0x0H should not be too short, so as to avoid excessive occupation of available bandwidth.

Presently, the format of LFP frames is identical to that of standard 802.3x PAUSE frame in order to simplify LFP frame transparent scheme; however, other formats may also be acceptable if corresponding format conversion at the receiving end in LFP transparent mode is performed; as for LFP frame regeneration scheme, format conversion is unnecessary because the LFP frames are only transferred between EoS devices.

The present invention is also applicable to SONET network, and the principle and control process are similar. So the case in which the present invention is applied to SONET network will not be described here.

1-7. (canceled)

8. A flow-control method for data traffic transmitted through a synchronous digital hierarchy (SDH) network, comprising:
creating and encapsulating, during data transmission through said SDH network, one or more line flow-control protocol (LFP) frames, according to a utilization condition of a frame cache of a first Ethernet over SDH/SONET (EoS) device coupled to said SDH network, wherein each LFP frame is mapped to an SDH payload as a common data frame;
transferring said one or more LFP frames to a second EoS device coupled to said SDH network;
demapping the SDH payload at said second EoS device;
identifying said one or more LFP frames at said second EoS device; and
phrasing and executing flow-control information contained in said one or more LFP frames at said second EoS device.

9. The flow-control method according to claim 8, wherein said creating and encapsulating comprises:
continuing to monitor data volume in an uplink direction in said frame cache of said first EoS device;
inserting a control field into each of said one or more LFP frames, said control field being based upon said data volume in said frame cache, wherein:
if said data volume exceeds an upper threshold, said encapsulating includes periodically sending LFP frames whose control field controls to stop sending;
if said data volume falls below a lower threshold, said encapsulating includes periodically sending LFP frames whose control field controls to start sending; and
if said data volume falls between said upper threshold and said lower threshold,
said encapsulating does not send LFP frames; and
wherein said one or more LFP frames are inserted at the head of a data queue for encapsulation and are given priority, and wherein if there are no Ethernet frames being encapsulated, the LFP frames are immediately encapsulated, and otherwise, the LFP frames are encapsulated immediately after current Ethernet frames are encapsulated.

10. The flow-control method according to claim 9, wherein a carrier for LFP frames is configured according to a standard IEEE 802.3x PAUSE frame structure.

11. The flow-control method according to claim 9, wherein if said data volume exceeds said upper threshold, the control field will contain 0x0FFFFH, and if said data volume falls below said lower threshold, the control field will contain 0x0H; and wherein said control field is controlled in an Xon/Xoff fashion.

12. The flow-control method according to claim 8, wherein a carrier for LFP frames is configured according to a standard IEEE 802.3x PAUSE frame structure.

13. The flow-control method according to claim 8, wherein said second EoS device processes said LFP frames in an LFP frame regeneration pattern, said framing and executing comprising:
if the control field in an LFP frame does not control to start sending, halting encapsulating of data at said second EoS device to cause data to stack up and to cause a user device coupled to said second EoS device to stop sending Ethernet frames, said LFP frame being defined by IEEE 802.3x as a PAUSE frame or a back pressure signal; and
if the control field in an LFP frame controls to start sending, continuing to normally encapsulate and map data at said second EoS device.

14. The flow-control method according to claim 13, wherein when said user device coupled to said second EoS device stops sending data to said second EoS device, the data volume in the data cache of said first EoS device decreases gradually;
wherein when the data volume in the data cache of said first EoS device reaches said lower threshold, the first EoS device generates at least one LFP frame having a control field to start sending; and
wherein said LFP frames are given priority for decapsulation at said second EoS device to phrase and execute flow-control to control the user device coupled to said second EoS device to send data again.

15. The flow-control method according to claim 8, wherein an LFP transparent pattern is used when said second EoS device identifies and processes an LFP frame; and
wherein said second EoS device explains and executes said LFP frames according to whether said user device coupled to said second EoS device supports full duplex, wherein:
if said user device works in full duplex mode, it is unnecessary to phrase the LFP frames, and the LFP frames are sent directly to said user device; and
if said user device works in half duplex mode, the control field of each LFP frame is phrased, wherein if the control field controls to start sending, a back pressure control signal will be cancelled, and otherwise, the back pressure control signal will be sent to make said user device detect a conflict and stop transmitting data.

16. The flow-control method according to claim 15, wherein when said user device coupled to said second EoS device stops sending data to said second EoS device, the data volume in the data cache of said first EoS device decreases gradually;
wherein when the data volume in the data cache of said first EoS device reaches said lower threshold, the first EoS device generates at least one LFP frame having a control field to start sending; and
wherein said LFP frames are given priority for decapsulation at said second EoS device to phrase and execute flow-control to control the user device coupled to said second EoS device to send data again.

17. A flow-control method for data traffic transmitted through a synchronous digital hierarchy (SDH) network, comprising:
monitoring, at a first device coupled to said SDH network, a receive data cache to determine a data volume in said receive data cache;
comparing said data volume to a predetermined upper threshold and a predetermined lower threshold;
creating and transmitting one or more flow-control frames to a second device coupled to said SDH network if said data volume is not between said upper threshold and said lower threshold, wherein if said data volume is greater than said upper threshold, at least one of said flow-control frames contains a control field to control said second device to stop transmitting data, and where if said data volume is less than said lower threshold, at least one of said flow-control frames contains a control field to control said second device to start sending data.

18. The flow-control method according to claim 17, wherein each of said first and second devices comprises an Ethernet over SDH/SONET (EoS) device.

19. The flow-control method according to claim 17, wherein a carrier of said flow-control frames is configured to have a PAUSE frame structure defined under the IEEE 802.3x standard.

20. The flow-control method according to claim 17, wherein said control field to stop transmitting data comprises 0x0FFFFH and said control filed to start sending data comprises 0x0H.

21. The flow-control method according to claim 20, wherein Xon/Xoff control is used to control said control field.

22. The flow-control method according to claim 17, wherein said creating and transmitting one or more flow-control frames includes:
encapsulating control information; and
mapping a result of said encapsulating.

23. The flow-control method according to claim 22, wherein said encapsulating control information comprises:
encapsulating at least one said flow-control frame before encapsulating any other frames unless there are data frames in the process of being encapsulated, in which case the at least one said flow-control frame is encapsulated immediately following encapsulating said data frames.

24. The flow-control method according to claim 17, wherein said creating and transmitting one or more flow-control frames includes:
periodically transmitting flow-control frames to control said second device to stop transmitting data, as long as said data volume remains above said upper threshold.

25. A flow-control method for data traffic transmitted through a synchronous digital hierarchy (SDH) network, comprising:
receiving, at a first device coupled to said SDH network, one or more flow-control frames from a second device coupled to said SDH network, wherein each flow-control frame contains a control field that controls a data device coupled to said first device to either stop sending data or start sending data, where said control field is selected based on a comparison of a data volume in a receive cache of said second device to predetermined upper and lower thresholds; and
processing said one or more flow-control frames at said first device to control a data device coupled to said first device to stop transmitting data or start transmitting data.

26. The flow-control method according to claim 25, wherein said processing comprises:
identifying the one or more flow-control frames; and
processing the one or more flow-control frames in a transparent manner according to whether the data device coupled to said first device operates in a full-duplex mode or a half-duplex mode, wherein:
if the data device coupled to said first device operates in a full-duplex mode, each of said one or more flow-control frames is transferred directly to the data device; and
if the data device coupled to said first device operates in a half-duplex mode, the first device executes a control function indicated by the one or more flow-control frames.

27. The flow-control method according to claim 26, wherein when said first device executes a control function indicated by the one or more flow control frames, executing the control function causes the first device to either transmit or to refrain from transmitting a back pressure signal to said data device.

28. The flow-control method according to claim 25, wherein said processing comprises:
identifying the one or more flow-control frames; and
processing the one or more flow-control frames in a regenerative manner.

29. The flow-control method according to claim 28, wherein said processing the one or more flow-control frames in a regenerative manner comprises:
ceasing to receive data from said data device by said first device if a flow-control frame received from said second device indicates to control said data device to stop transmitting; and
normally processing data from said data device by said first device if a flow-control frame received from said second device indicates to control said data device to start transmitting.
